(19) United States
(12) Patent Application Publication
(10) Pub. No.: US 2021/0039985 A1
(43) Pub. Date: Feb. 11, 2021

(54) HYBRID MID-IR-LIGHT TRANSMITTING FIBER

(71) Applicants: Shibin Jiang, Tucson, AZ (US); Tao Luo, Tucson, AZ (US)

(72) Inventors: Shibin Jiang, Tucson, AZ (US); Tao Luo, Tucson, AZ (US)

(21) Appl. No.: 16/533,339

(22) Filed: Aug. 6, 2019

(51) Int. Cl. C03C 13/04; C03C 4/10

(52) U.S. Cl. CPC C03C 13/044; C03C 4/10; C03C 13/046

(57) ABSTRACT

A hybrid mid-infrared-light transmitting glass fiber comprising a non-oxide infrared-light transmitting glass core, non-oxide glass inner cladding, and an oxide glass external cladding. In certain embodiments, the hybrid mid-infrared transmitting glass fiber is configured as a single mode fiber at a specific wavelength. In certain embodiments, the hybrid mid-infrared-light transmitting glass fiber is configured a polarization maintaining single mode fiber at a chosen specific wavelength.

### GOVERNMENT RIGHTS

This invention was made with government support under contract No. FA9550-17-C-0016 awarded by Department of Defense. The government has certain rights to this invention.

### TECHNICAL FIELD

This invention relates to optical fibers configured to transmit mid-infrared light and, more particularly, to mid-infrared-light transmitting glass fibers the structure of which includes three different layers and two different types of glass material.

### BACKGROUND

Optical fibers for transmission in the mid-infrared (mid-IR) spectral region (referred to hereinafter as MIRFs), from about 1 micron to about 20 microns, are desirable for a wide variety of applications such as, for example, infrared countermeasure (IRCM) systems, chemical and temperature sensing, laser delivery medium, and lightguide delivery cables for spectroscopy. However, such fibers are expensive, brittle, and fragile, limiting their practical application. While significant effort has been devoted to developing infrared-light-transmitting fibers that are both physically strong and have a low propagation loss, little progress has been made due to the inherent characteristics of mid-infrared transmissive fibers. The absorption of a solid in the long-wavelength limit is determined by the multiphonon, or infrared (IR), absorption edge and arises from inner molecule or lattice vibrations of the materials. As will be appreciated by one of ordinary skill in the art, to push the IR absorption edge toward longer wavelengths, the forces of attraction between ions of the involved glass materials should be low, i.e., the mass of the ions should be high, meaning that that glass that is strongly transmissive in the mid-IR range is inherently physically weak. While the most commonly used (due to its low propagation loss) fiber for mid-infrared applications is a chalcogenide glass fiber, such fiber is also physically weak, making it extremely difficult to have uses for fiber-optical cable assembly. In addition, most chalcogenide glasses contain toxic elements. These disadvantages of chalcogenide glass restrict its practical use. One the other hand, the practical use of typical oxide glasses for IR-light transmitting fibers is extremely limited because of the poor transmission of this material at IR wavelengths.

### SUMMARY

In one implementation, a single mode mid-infrared-light transmitting glass fiber is presented wherein the mid-infrared transmitting glass fiber comprises a non-oxide infrared transmitting glass core, a non-oxide infrared transmitting glass inner cladding, and an oxide glass external cladding. The core of the hybrid fiber supports single spatial mode IR transmitting glass and the external cladding is a non-toxic oxide glass.

In a specific case, a non-oxide infrared-light transmitting glass core has a V-number of less than 2.405; a non-oxide infrared-light transmitting glass inner cladding has a thickness larger than 5 micron; and the IR-transmission of such glass core exceeds 20% per meter of length, while materials of the core and inner cladding are selected from the group consisting of chalcogenide glass and fluoride glass.

In another implementation, a polarization maintaining (PM) single mode mid-infrared transmitting glass fiber is presented wherein the mid-infrared transmitting glass fiber comprises a non-oxide infrared transmitting glass core, a non-oxide infrared transmitting glass inner cladding, an oxide glass external cladding, and inserting stress rods in the external cladding layer to form polarization maintaining fiber. The core of the hybrid fiber supports single spatial mode IR transmitting glass and the external cladding is a non-toxic oxide glass. In a specific case, a non-oxide infrared-light transmitting glass core has aperture V-number of less than 2.405 and transmittance exceeding 20% per meter length; and a non-oxide infrared-light transmitting glass inner cladding with a thickness larger than 5 micron.

The scope of the invention additionally includes a method for structuring and/or forming a mid-infrared-light transmitting glass fiber claimed in the appended claims. The method includes, for example, the formation of a fiber-optic preform including a first preform of a core configured from a non-oxide IR-light-transmitting glass and a second preform of an inner cladding configured from a non-oxide IR-light transmitting glass. The materials of the first and second preforms are selected from the group consisting of a chalcogenide glass and a fluoride glass. The method additionally includes the step of forming a third preform of an outer cladding that encloses both the first and second preforms that, in turn, are nested in one another. The method may additionally include a step of drawing an optical fiber, from the combination of the first, second, and third preforms with at least one stress rod disposed along the length of the fiber, to form a fiber with an aperture-number of less than 2.405 and the core having IR-transmittance figure exceeding 20% per meter of length of the fiber and inner cladding that is thicker than 5 microns.

### BRIEF DESCRIPTION OF THE DRAWINGS

Implementations of the invention will become more apparent from the detailed description set forth below when taken in conjunction with the drawings, in which like elements bear like reference numerals.

FIG. 1 is an exemplary diagram of the cross-section and refractive index of an embodiment of the hybrid single-mode fiber (SMF).

FIG. 2 is a schematic of an exemplary fiber preform for the embodiment of FIG. 1.

FIG. 3 is an exemplary diagram of the cross-section and refractive index of an embodiment of the hybrid single-mode polarization-maintaining (PM) fiber.

FIG. 4 is an exemplary diagram of the cross-section and refractive index of an embodiment of the hybrid multimode fiber (MMF).

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

Implementations provide a hybrid optical fiber that is transmissive in the mid-IR range, mechanically strong, and less toxic to use (in comparison with those of related art). The term “mechanically strong” refers to and is defined by either tensile strength or flexion strength. As a person of ordinary skill in the art well recognizes, infrared radiation is electromagnetic radiation with wavelengths ranging between about 0.7 and about 300 microns. Generally, the infrared range is divided into three spectral regions: near-IR region, mid-IR region, and far-IR region, however the boundaries between the spectral regions are not universally agreed upon and are somewhat uncertain. As used herein, the mid-IR range is considered to extend from about 1 micron to about 20 microns.

Throughout the following description, this invention is described on examples of preferred embodiments and with reference to the figures in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. Numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring details of implementation(s) of the idea of the invention.

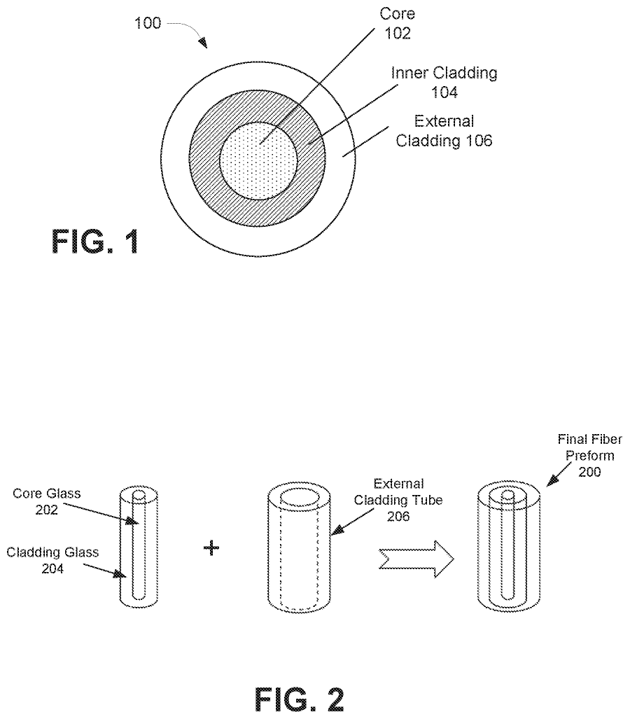

FIG. 1 presents an exemplary schematic 100 of the cross-section of an embodiment of a hybrid SMF that is transmissive in the mid-infrared range with more than 20% transmission per meter length, mechanically strong enough for handling, less toxic to use. The core 102 and the inner cladding 104 of the fiber of the embodiment are comprised of chalcogenide glass materials with high IR transmission. As will be known to one of ordinary skill in the art, chalcogenide glasses are composed of one or more chalcogenide elements as a substantial constituent (typically, in excess of 90%), where the chalcogenide element is commonly selected from the group arsenic (As), germanium (Ge), antimony (Sb), phosphorus (P), tellurium (Te), selenium (Se), and sulfur (S). The external cladding 106 is made of an oxide glass exhibiting good mechanical strength (such as, and without limitation, silicate glass, phosphate glass, germanate glass, tellurite glass, borate glass, aluminate glass, or bismuth glass, to name just a few). In certain embodiments, the external cladding 106 is made of silicate glass known to exhibit high mechanical strength and having a relatively low softening temperature. The external cladding glass does not contain elements that are toxic to human beings. Therefore, the embodiment 100 of the fiber is less toxic to handle and process as compared to the one without the external oxide glass cladding layer.

The index of refraction of the core 102 is higher than the index of refraction of the inner cladding 104. Whether the core 102 supports single spatial mode or exhibits a multimode behavior at wavelength λ (measured in vacuum) is determined according to the following equation :

$$V = \frac{2 π}{λ} \text{?} NA = \frac{2 n}{λ} \text{?} \sqrt{{n}_{\text{?}}^{2} - {n}_{\text{?} }^{2}}$$

$$\text{?} \text{indicates text missing or illegible when filed}$$

where a is the radius of the fiber core, and NA is the numerical aperture of the fiber. The numerical aperture of the fiber is assessed as the sine of the maximum angle (with respect to the fiber axis) at which the light ray, incident onto the fiber facet, is accepted and coupled into the fiber to propagate within the fiber. The NA can be calculated from the difference of refractive indexes between that of a core and that of a cladding. When the V-number is below 2.405, the core of the fiber supports a single mode of light at a given wavelength. When the V-number is larger than 2.405, the core of the fiber supports multimode operation.

Typically, the refractive index of the external cladding oxide glass 106 is lower than that of the inner cladding IR transmitting glass 104.

In one implementation, the thickness of the inner cladding 104 (defined as the difference between the outer and inner diameters of this cladding) is chosen to be larger than 5 micron in order to effectively confine the light in the core 102 and to not cause any significant propagation loss (that is, the presence of the inner cladding substantially confined propagating light mode(s) to the core of the fiber).

Oxide glasses exhibit much higher mechanical strength than non-oxide glasses. The term non-oxide refers to and is used in conjunction with glasses containing less than 2 weight % of oxide materials. Non-oxide glasses include, but are not limited to, chalcogenide glasses and fluoride glasses.

The glass-network former in silicate glasses is SiO₂, and the bond strength of Si—O is much higher than the bond strengths of As—S, As—Se, Ge—S, Ge—Se, Te—Se, and Te—As. The mechanical strength of a fiber can be determined as either tensile strength or bending strength, which is linearly proportional to Young's modulus, the measure of the stiffness of an isotropic elastic material. The Young's modulus of arsenic trisulfide, As₂S₃, glass is 18 GPa, while those for most silicate glasses are between 70 and 90 GPa. Thus, silicate glass fibers are more than four (4) times stronger than an As₂S₃ glass fiber, which is one of the strongest chalcogenide glass fibers.

According to the implementation of the idea of the invention, the mechanical strength of the embodiment of the hybrid fiber of the invention is further increased due to the large cross-sectional area of external cladding 106. Table 1 below shows the cross-sectional areas of core, inner cladding, and external cladding for three different fiber implementations with various core, inner cladding, and external cladding diameters. The inner cladding diameter is judiciously adjusted to ensure that the beam of light propagating in the core of the fiber does not reach the external cladding. As can be seen from Table 1, the cross-sectional area of the external cladding contributes mostly into the area of the total cross-section of the embodiment of the fiber. As the mechanical strength of glass fiber is mainly determined by the cross section area, in certain embodiments the mechanical strength of the embodiment of the hybrid fiber of the invention is twice that of an As₂S₃ glass fiber.

TABLE 1
Cross-sectional geometrical characteristics for different hybrid fibers.

| | | | | | | | Total fiber | |
|---|---|---|---|---|---|---|---|---|
| | | | Inner Cladding | | External Cladding | | cross | Ratio of |
| | Core | | | Area | | Area | section | Area III to |
| | Diameter | Area I | Diameter | II | Diameter | III | area IV | Area IV |
| | (μm) | (μm²) | (μm) | (μm²) | (μm) | (μm²) | (μm²) | (%) |
| Single | 20 | 314 | 40 | 942 | 125 | 11009 | 12266 | 89.8% |
| mode Fiber | | | | | | | | |
| Single | 30 | 707 | 50 | 1231 | 125 | 10327 | 12266 | 84.2% |
| mode Fiber | | | | | | | | |
| Multimode | 60 | 2826 | 90 | 3533 | 200 | 25042 | 31400 | 80% |
| Fiber 3 | | | | | | | | |

It should be noted that the coefficient of thermal expansion (CTE) of the chalcogenide glass material is very different than that of the silicate glass. The typical CTE values, of chalcogenide glass and silicate glass, are around 250×10⁻⁷° C.⁻¹ (one over degree Celsius) and 100×10⁻⁷° C.⁻¹ (one over degree Celsius), respectively. The Applicant has developed chalcogenide glasses with a lower value of CTE and oxide glasses with a higher CTE to match the chalcogenide and oxide glasses. During the fiber drawing process, when the fiber is cooling from the softening temperature down to room temperature, strong mechanical contraction occurs because of the relatively larger CTE of chalcogenide glass as compared to that of the silicate glass. This strong contraction causes compression stress in the external cladding layer and even further increases the mechanical strength of the fiber.

Purification of the glass material of the core 102 and the glass material of the inner cladding 104 is important to achieve low light attenuation upon propagation through the fiber. In the preferred method, high-purity glasses for core 102 and inner cladding 104 are prepared from 99.9999% purity starting elements using a high vacuum technique. Starting elements are etched to remove surface oxidation and introduced into silica tubes connected to a high-vacuum line. Specific elements are heated in situ to sublime high vapor pressure oxide contaminants (such as SeO). The glass is then purified by distillation.

As will be appreciated by one of ordinary skill in the art, the purification process described above may be repeated until satisfactory purity is obtained. In certain embodiment satisfactory purity is obtained when the attenuation of the resulting fiber is 0.1 dB/m (and, more generally in a related embodiment, <1 dB/m).

Generally, however, any other method for purifying glass for use in optical fibers may be used without departing from the scope of the present invention.

In certain embodiments, an embodiment of the hybrid fiber is fabricated using the rod-in-tube technique. The hybrid fiber can also be fabricated using double crucible method, triple crucible method, and other methods. As will be known by one of ordinary skill in the art, optical fibers are typically made by heating and drawing a portion of an optical preform comprising a solid glass rod with a refractive glass core surrounded by a protective glass cladding. The glass cladding is formed on the glass core using the rod-in-tube technique whereby an overclad tube is collapsed around the core. To this end, FIG. 2 provides a diagram of the formation of an exemplary preform 200 of the embodiment of the hybrid fiber in which the external cladding tube 206 is collapsed around glass core 202 and cladding glass 204 to form preform 200.

The drawing process used to fabricate an embodiment of the hybrid fiber of the invention is carried out on a fiber drawing tower. Preferably, the fiber drawing is performed under an atmosphere of high-purity Argon gas to ensure that oxidation of the materials does not occur during the fiber drawing process (because oxidation increases the attenuation of light at the infrared wavelengths).

Due to the higher mechanical strength of of the embodiment of the discussed hybrid fiber as compared to that of mid-infrared transmissive fiber discussed in related art, the ends of Applicants' hybrid fiber can be easily mechanically polished for assembly and/or use of the embodiment in a fiber cable, in advantageous contradistinction with embodiments of related art.

Furthermore, the embodiments of the hybrid fiber of the invention are substantially less toxic (as explained in the following, the toxic materials are not directly exposed when a person handles the fiber) than typical infrared fibers (such as chalcogenide glass fibers, for example) due to the structure of the surrounding layer of the external oxide glass of the embodiment. Not only is the total amount of toxic material reduced with the proposed embodiment of the hybrid fiber, but also the toxic materials are not directly exposed unless the external glass cladding layer corrodes.

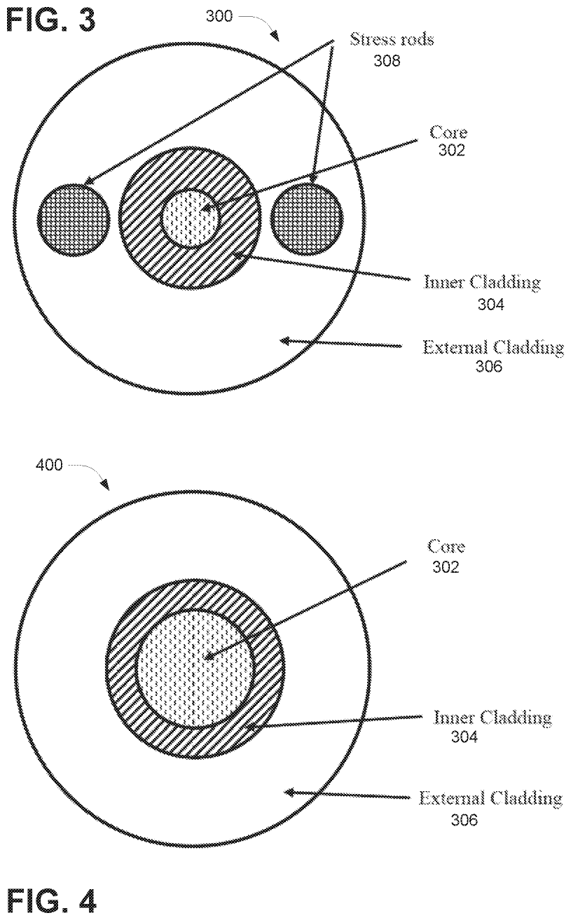

FIG. 3 presents a schematic diagram 300 of embodiment of the hybrid SMF that is transmissive in the mid-infrared range, mechanically strong, and less toxic to use than embodiments of the related art, in the cross-sectional view. The core 302 and the inner cladding 304 are comprised of chalcogenide glass materials with high infrared transmission. The external cladding 306 is an oxide glass exhibiting good mechanical strength (such as, and without limitation, silicate glass, phosphate glass, germanate glass, tellurite glass, borate glass, aluminate glass, and bismuth glass). In certain embodiments, the external cladding 306 is made of silicate glass exhibiting high mechanical strength and having a relatively low softening temperature. The external cladding glass does not contain elements toxic to human beings. Therefore, the embodiment of the fiber is less toxic to handle and process compared to the one without the external oxide glass cladding layer. At least one stress rod 308 (as shown—two stress rods), disposed along the length of the fiber 300 in one of the claddings (preferably—in the external classing 306) is used to cause the core 302 to exhibit birefringent behavior, leading the fiber 300 to become a PM fiber.

A PM fiber is a highly birefringent fiber, presenting, in operation, two axes of polarization to light propagating in the fiber such that the coupling of radiative power between the two axes is very weak. A commonly-used method for introducing strong birefringence is to include two so-called stress inserting rods (also called stress rods) in the preform on opposite sides of the core. The stress inserting rods should exhibit significantly different thermal properties compared to those of the cladding glass. Typically, the glass transition temperature of the stress inserting rods is lower than that of the cladding glass and the thermal expansion coefficient is much higher than that of the cladding glass. When the fiber is cooled down, during the fabrication, from the fiber-pulling temperature the stress inserting rods continue to shrink when the cladding glass is solidified, which causes compression on the core of the fiber. The compression on the core results in birefringence. There are two stress inserting rods, which produce some mechanical stress with a well-defined orientation.

The stress inserting rods 308 are shown to be disposed in the external cladding oxide glass layer. This design offers critical advantage in making PM fiber because of the extremely broad glass-forming region of oxide glasses as compared to the IR transmitting glasses. (Oxide glasses such as glasses used for windows, can be formed to possess a wide range of properties.) Oxide glass with much lower glass transition temperature and higher thermal expansion coefficient compare to the outer cladding glass can be designed and fabricated.

In one example, the diameters of core and inner cladding are around 20 microns and 40 microns, respectively. The diameter of the stress inserting rods is about 40 microns, and the outer diameter of the fiber is be around 150 microns. In another example, the diameters of core and inner cladding are around 60 microns and 80 microns, respectively. The diameter of the stress inserting rods is about 60 microns, and the outer diameter of the fiber is around 250 microns.

FIG. 4 illustrates the cross-section 400 of an embodiment of the hybrid multimode mode fiber (MMF) that is transmissive in the mid-infrared range, mechanically strong, and less toxic to use than embodiments of the related art. The core 302 and inner cladding 304 shown in cross-section 400 are chalcogenide glass materials with high infrared transmission. External cladding 306 is an oxide glass exhibiting good mechanical strength (such as, and without limitation, silicate glass, phosphate glass, germanate glass, tellurite glass, borate glass, aluminate glass, and /or bismuth glass).

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

It is also to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, for purposes of simplifying the given drawing and discussion, and to direct the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this detail in the drawing may be implied unless the context of the description requires otherwise. In other instances, well known structures, details, materials, or operations may be not shown in a given drawing or described in detail to avoid obscuring aspects of an embodiment of the invention that are being discussed.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

Other specific examples of the meaning of the terms “substantially”, “about”, and/or “approximately” as applied to different practical situations may have been provided elsewhere in this disclosure.

The invention as recited in claims appended to this disclosure is intended to be assessed in light of the disclosure as a whole. Various changes in the details, steps and components that have been described may be made by those skilled in the art within the principles and scope of the invention.

While the invention is described through the above-described exemplary embodiments, it will be understood by those of ordinary skill in the art that modifications to, and variations of, the illustrated embodiments may be made without departing from the inventive concepts disclosed herein. Accordingly, the invention should not be viewed as being limited to the disclosed embodiment(s).

1. A hybrid mid-infrared-light transmitting glass single mode fiber (SMF) comprising:
a non-oxide infrared-light transmitting glass core with a V number of less than 2.405; a non-oxide infrared-light transmitting glass inner cladding with a thickness larger than 5 micron; and
an oxide glass outer cladding;
wherein transmission of said glass core exceeds 20% per meter of length;
wherein materials of the core and inner cladding are selected from the group consisting of chalcogenide glass and fluoride glass.

2. The fiber according to claim 1, wherein the chalcogenide glass comprises a chalcogenide element selected from the group consisting of:
As; Ge; Sb; P; Te; Se; and S.

3. The fiber according to claim 1, wherein the oxide glass material of the external cladding includes at least one of a silicate glass, a phosphate glass, a germanate glass, a tellurite glass, a borate glass, an aluminate glass, and a bismuth glass.

4. A hybrid mid-infrared-light transmitting glass polarization maintaining single mode fiber (PM SMF) comprising:
a non-oxide infrared-light transmitting glass core with a V number of less than 2.405 and transmittance exceeding 20% per meter length ; and
a non-oxide infrared-light transmitting glass inner cladding with a thickness larger than 5 micron;
an oxide glass outer cladding layer;
two inserting stress rods inside of the oxide glass outer cladding layer of the fiber;
an oxide glass outer cladding; and
wherein materials of the core and inner cladding are selected from the group consisting of chalcogenide glass and fluoride glass.

5. The fiber according to claim 4, wherein the chalcogenide glass comprises a chalcogenide element selected from the group consisting of:
As; Ge; Sb; P; Te; Se; and S.

6. The fiber according to claim 4, wherein the oxide glass material of the external cladding includes at least one of a silicate glass, a phosphate glass, a germanate glass, a tellurite glass, a borate glass, an aluminate glass, and a bismuth glass.

7. A hybrid mid-infrared-light transmitting glass multimode fiber comprising:
a non-oxide infrared-light transmitting glass core with a V number smaller than 2.405 and transmittance exceeding 20% per meter length;
a non-oxide infrared-light transmitting glass inner cladding with a thickness larger than 5 micron;and
an oxide glass outer cladding;
wherein materials of the core and inner cladding are selected from the group consisting of chalcogenide glass and fluoride glass.

8. The fiber according to claim 7, wherein the chalcogenide glass comprises a chalcogenide element selected from the group consisting of:
As; Ge; Sb; P; Te; Se; and S.

9. The fiber according to claim 7, wherein the oxide glass material of the external cladding includes at least one of a silicate glass, a phosphate glass, a germanate glass, a tellurite glass, a borate glass, an aluminate glass, and a bismuth glass.
